(19) United States
(12) Patent Application Publication
(10) Pub. No.: US 2020/0098072 A1
(43) Pub. Date: Mar. 26, 2020

(54) EMPLOYER AND WORKER REVIEW PLATFORM WITH ON DEMAND EMPLOYMENT CONTRACTS

(71) Applicant: Elizabeth Hurtado Escobar, Charlotte, NC (US)

(72) Inventor: Elizabeth Hurtado Escobar, Charlotte, NC (US)

(21) Appl. No.: 16/581,705

(22) Filed: Sep. 24, 2019

Related U.S. Application Data
(60) Provisional application No. 62/735,827, filed on Sep. 24, 2018.

(51) Int. Cl. G06Q 50/18; G06Q 20/38

(52) U.S. Cl. CPC G06Q 50/188; G06Q 20/389

(57) ABSTRACT

A method and system for creating employment contracts and possession contracts between users which are stored on a blockchain ledger. The system includes a plurality of verified users. The users post jobs and possessions open for bidding from other users. Once bids are accepted, the system creates a contract and enables verification of fulfillment of the contract, as well as automatic payment, all of which is stored on the blockchain ledger, in part.

### CROSS REFERENCE TO RELATED APPLICATIONS

This application claims the benefit of U.S. Provisional Application No. 62,735,827 filed Sep. 24, 2018, which is herein incorporated by reference in its entirety.

### TECHNICAL FIELD

The present invention relates generally to systems and methods for creating contracts between employers and workers. Specifically, a reputation score for the employer and worker is generated using information on a distributed ledger for creating the contract and tracking the contract's utilization.

### BACKGROUND

Worker migration to other cities or countries continues to increase. The worker's customer network may be non-existent in the city or country to which they migrate, creating hardship and loss of income. Moreover, for blue-collar jobs, word of mouth is still one of the most popular methods for acquiring new clients, which emphasizes the critical problem faced by unemployed, migrating workers attempting to attract new clients in their new location.

Many blue-collar workers rely on internet reviews for attracting new clients in need of their services. However, the majority of service review platforms provide business reviews rather than individual worker reviews, and generally lack information regarding a worker's job history. There remains a need for a platform to enable a worker's job history and performance for particular employers to be stored in a trustworthy and reliable manner.

This presently disclosed invention utilizes a blockchain-based ledger e.g., a distributed, remotely accessible, immutable ledger) for creation and development of a worker and employer reputation score, including work history. By permitting crowd-source reviews, migratory workers can maintain a global reputation that is immutable and stored in using the blockchain system. Furthermore, the disclosed invention enables the creation, modification and execution of employment contracts utilizing the blockchain-based ledger smart contracts). The employment contracts and their execution may be utilized to alter reputation scores.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

According to at least one embodiment, a system is provided including: at least one processor; and at least one storage medium for storing instructions for execution by the at least one processor for causing the system to: receive from a first user device first user attributes and transaction attributes; receive from a second user device second user attributes and a bid corresponding to the transaction attributes; receive from the first user device an acceptance of the bid; create a contract including components of the first user attributes, second user attributes and the transaction attributes; and store some of the components on a blockchain-based ledger.

According to at least another embodiment, a method is provided including execution of the system.

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 illustrates a blockchain-based ledger that can be utilized for creating a reputation score and/or employment contract, according to at least one embodiment of the present disclosure.

FIG. 2 illustrates a service system in which user devices interact with a service database for adding and confirming transactions on a blockchain-based ledge, according to at least one embodiment of the present disclosure.

FIG. 3 illustrates a user device, according to at least one embodiment of the present disclosure.

FIG. 4 illustrates a server, according to at least one embodiment of the present disclosure.

FIG. 5 illustrates user profiles of users, according to at least one embodiment of the present disclosure.

FIG. 6 illustrates a service system for creating contracts, according to at least one embodiment of the present disclosure.

FIG. 7 illustrates a service system for creating contracts, according to at least one embodiment of the present disclosure.

FIG. 8 illustrates a service system for renting possessions, according to at least one embodiment of the present disclosure.

FIG. 9 illustrates additional user attributes, according to at least one embodiment of the present disclosure.

FIG. 10 illustrates transaction attributes, according to at least one embodiment of the present disclosure.

### DETAILED DESCRIPTIONS

The following description and drawings are illustrative and are not to be construed as limiting. Numerous specific details are described to provide a thorough understanding of the disclosure. However, in certain instances, well-known or conventional details are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

As will be appreciated by one of ordinary skill in the art in view of this disclosure, the invention may be embodied as an apparatus (including, for example, a system, machine, device, computer program product, or any other apparatus), method (including, for example, a business process, computer-implemented process, or any other process), a system, a computer program product, and/or any combination of the foregoing. Accordingly, embodiments of the invention may take the form of an entirely software embodiment (including firmware, resident software, micro-code, etc.), an entirely hardware embodiment, or an embodiment combining software and hardware aspects that may generally be referred to herein as a system. Furthermore, embodiments of the invention may take the form of a computer program product having a computer-readable storage medium having computer-executable program code embodied in the medium.

As used herein, a plain reference numeral (e.g. like 110) may refer generally to a member of a class of items (e.g. like ledger blocks) exemplified with a hybrid numeral (e.g. like 110D) and it will be understood that every item identified with a hybrid numeral is also an exemplar of the class. Moreover although a reference numeral shared between figures refers to the same item, most figures depict respective embodiments.

As used herein, the term “blockchain” generally refers to an open and distributed public ledger comprising a growing list of records, which are linked using cryptography. By design, the blockchain is resistant to modification of the data. The blockchain can include an auditable database that provides a distributed, replicated ledger of cryptographically certified artifacts whose contents are extremely difficult to tamper with without detection, and therefore, are with very high probability, true copies of the intended content, and whose content are open for inspection via a suitable query interface.

As used herein, the term “block” generally refers to a record that is kept in a blockchain. For example, each block contains a cryptographic hash of the previous block, a timestamp, and transaction data, which can generally be represented as a Merkle tree root hash.

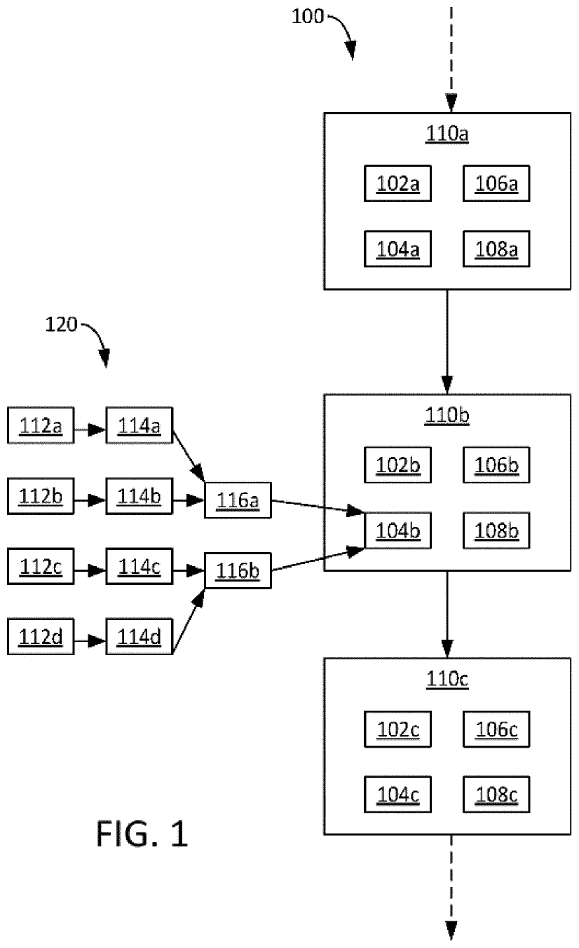

FIG. 1 illustrates a blockchain-based ledger 100 that can be utilized for creating a reputation score 210, contract 220 and/or possession 206, according to certain aspects of the disclosure. As shown, the blockchain-based ledger 100 includes several blocks 110. For simplicity, three blocks 110 are shown. Each block 110 includes a previous hash 102, a transaction root 104, a timestamp 106, and a nonce 108.

The previous hash 102 is the value obtained by hashing a previous block 110 in the blockchain-based ledger 100. For example, if block 110b is the Nth block in the blockchain-based ledger 100, then the previous hash 102b is the value of the hash of block N-1, which in this case would be block 110a. Similarly, the previous hash 102c is the value of the hash of block 110b.

The transaction root 104 is the root hash value of a hash tree 120 (e.g., a Merkle tree) over all transactions to be added to the block 110. For example, transactions 112a, 112b, 112c, and 112d are to be added to block 110b. According to an aspect of the present disclosure, transactions 112a-112d may be any type of transaction, and may include any type of data of any length such as photographs, videos, sound recordings, etc. In order to add transactions 112a-112d to the blockchain-based ledger 100, each transaction 112a-112d is hashed to obtain hashed transactions 114a, 114b, 114c, and 114d. For example, hashing transaction 112a yields hashed transaction 114a, hashing transaction 112b yields hashed transaction 114b, and so on.

The hashed transactions 114a-114d are then hashed with each other to obtain hashes 116a and 116b. For example, hashed transaction 114a is hashed with hashed transaction 114b to obtain hash 116a, and hashed transaction 114e is hashed with hashed transaction 114d to obtain hash 116b. Finally, hash 116a is hashed with hash 116b to obtain the transaction root 104b. It will be appreciated that although the hash tree 120 for block 110b is shown, it is understood that all transaction roots 104 of all blocks 110 in the blockchain-based ledger 100 include a corresponding similar hash tree 120. As a result, each block 110 added to the blockchain-based ledger 100 is a confirmation of all the transactions that occurred before, making the blockchain-based ledger 100 effectively permanent and immutable. This is because it would be computationally impractical/impossible to modify the blocks 110 of the blockchain-based ledger 100 by any bad actors.

According to an aspect of the present disclosure, hashing can be accomplished using cryptographic hash functions such as, including, but not limited to, Secure Hash Algorithm (SHA) 0, SHA-1, SHA-2, SHA-3, . . . , SHA-256, etc., or Digital Signature Hash Algorithm (DSA).

In operation, rewards may be issued to those who add blocks 110 to the blockchain-based ledger 100. The rewards may include monetary fees or other incentives that may be spent either within or outside of the blockchain-based ledger 100. In order to maintain fairness of reward distribution and to ensure the integrity of the blockchain-based ledger 100, users must compete with each other to add each block 110. For example, users competing to add block 110b to the blockchain-based ledger 100 must include a proof-of-work to be considered valid. This proof-of-work is tied to the nonce 108 and is verified by other users (e.g., nodes) each time a block 110 is added. Although a proof-of-work system has been described, it is understood that the implementations also apply to other types of systems regardless of distributed consensus protocol, including but not limited to, distributed proof-of-stake.

According to an aspect of the present disclosure, the blockchain-based ledger 100 can include publicly distributed block headers, which is a technology known to meet the requirements of storing replicated artifacts in publicly available distributed storage facilities that cannot be tampered with, and that are readily available for inspection. According to an aspect, the blockchain-based ledger 100 is a public blockchain.

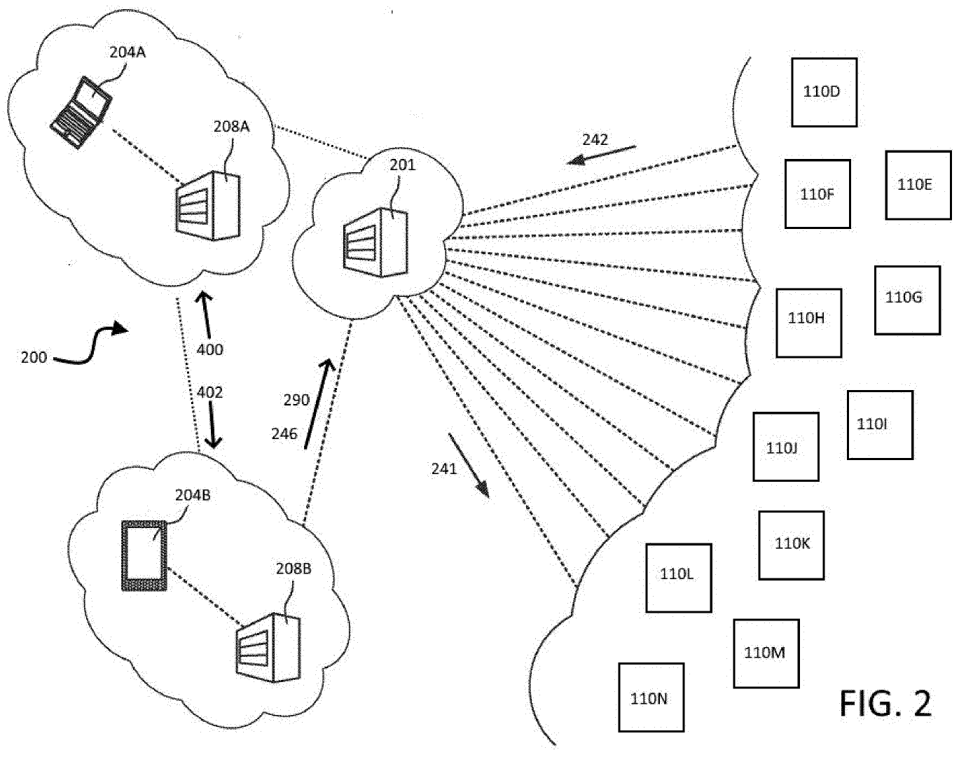

FIG. 2 schematically illustrates a service system 200 in which user devices 204 interact with a service database 201 for adding transactions 112 (by additions 241) or confirming transactions 112 (by confirmations 242) on blocks 110D-N of the blockchain-based ledger 100. In some variants one or more user device 204A, 204B may communicate with one or more node management servers 208A for communicating amongst the devices 204A, 204B and/or with the service server database 201. In some instances the devices 204A, 204B may cooperate so that additions 241 may occur in a decentralized fashion. The service system 200 may be configured for creating a reputation score 210 and/or a contract 212 by utilizing a blockchain-based ledger 100, according to certain aspects of the disclosure.

In some embodiments, the communications (e.g., 400, 402) between the user devices 204A, 204B may flow through the database 201 instead of directly amongst each other. The database 201 may take the form of a number of distributed databases (e.g., cloud network).

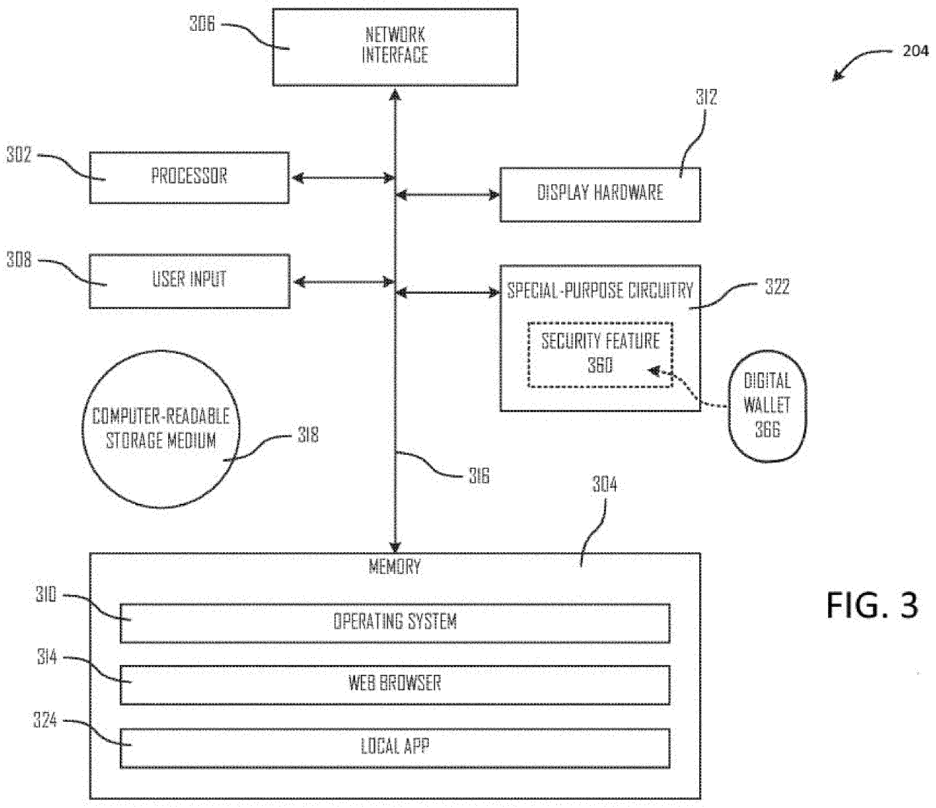

Referring now to FIG. 3, a user device 204 is illustrated. User device 204 may include one or more instances of processors 302, memory 304, user inputs 308, and display hardware 312 all interconnected along with the network interface 306 via a bus 316. One or more network interfaces 306 allow device 204 to connect via the Internet or other networks to or with the servers 208 and/or database 201 of FIG. 2. Memory 304 generally comprises a random access memory (“RAM”), a read only memory (“ROM”), and a permanent mass storage device, such as a disk drive.

Memory 304 may contain one or more instances of operating systems 310, web browsers 314, and local apps 324. These and other software components may be loaded from a non-transitory computer readable storage medium 318 into memory 304 of the user device 204 using a drive mechanism (not shown) associated with a non-transitory computer readable storage medium 318, such as a floppy disc, tape, DVD/CD-ROM drive, flash card, memory card, or the like. In some embodiments, software components may also be loaded via the network interface 306, rather than via a computer readable storage medium 318. Special-purpose circuitry 322 may, in some variants, include some or all of the event-sequencing logic described below (e.g. in a peer-to-peer implementation) and one or more security features 360 (e.g. a fob or similar security apparatus).

In some embodiments, security feature 360 may implement or otherwise interact with a removable or other digital wallet 366. Such wallets may (optionally) each include one or more instances of wallet private keys, utility tokens, crypto currency, provenance data, or device-executable code snippets. In some embodiments client device 204 may include many more components than those shown in FIG. 3, but it is not necessary that all conventional components be shown in order to disclose an illustrative embodiment.

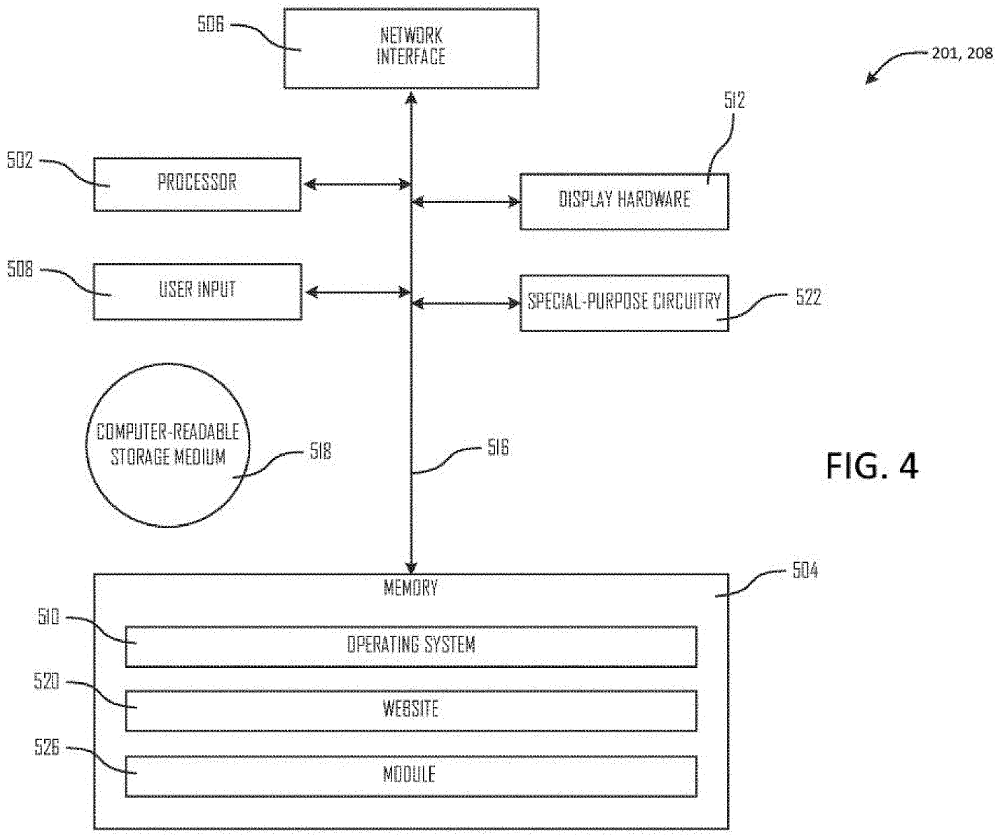

Referring now to FIG. 4, a server 201, 208 is illustrated. Server 201, 208 may include one or more instances of processors 502, memory 504, user inputs 508, and display hardware 512 all interconnected along with the network interface 506 via a bus 516. One or more network interfaces 506 allow server 201, 208 to connect via the Internet or other networks to each other or to other devices 204. Memory 504 generally comprises a random access memory (“RAM”), a read only memory (“ROM”), and a permanent mass storage device, such as a disk drive.

Memory 504 may contain one or more instances of operating systems 510, hosted websites 520, and modules 526. These and other software components may be loaded from a non-transitory computer readable storage medium 518 into memory 504 of the server 201, 208 using a drive mechanism (not shown) associated with a non-transitory computer readable storage medium 518, such as a floppy disc, tape, DVD/CD-ROM drive, flash card, memory card, or the like. In some embodiments, software components may also be loaded via the network interface 506, rather than via a computer readable storage medium 518. Special-purpose circuitry 522 may, in some variants, include some or all of the event-sequencing logic described below (e.g. in a peer-to-peer implementation) and one or more security features (e.g. a firewall). In some embodiments, the server 201, 208 may include many more components than those shown in FIG. 4, but it is not necessary that all conventional components be shown in order to disclose an illustrative embodiment.

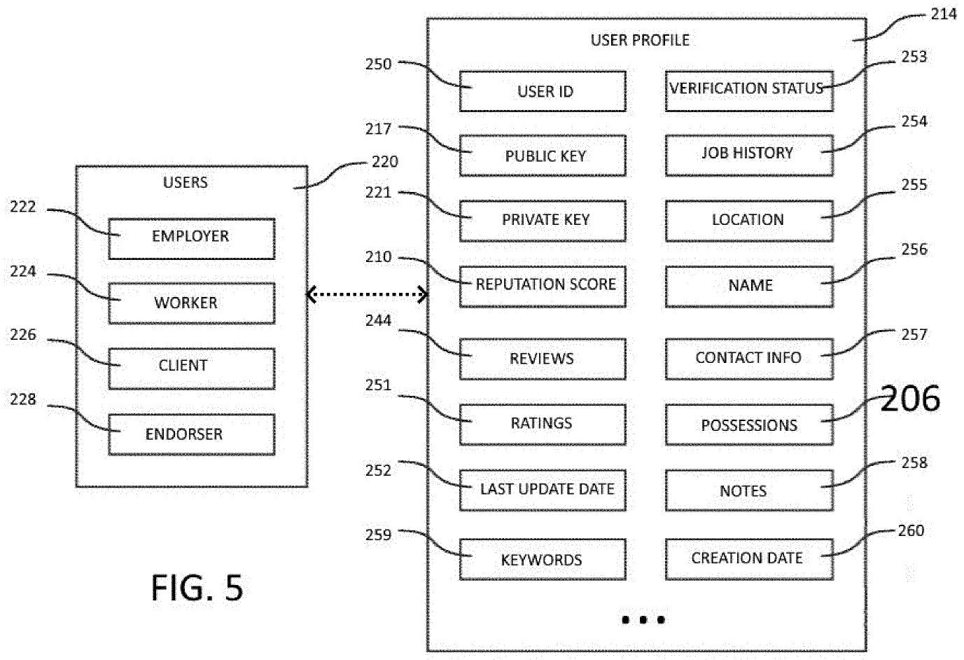

Referring now to FIG. 5, a user 220 of the system 200 may be an employer 222, a worker 224, a client 226 and/or an endorser 228. A client 226 may be in need of services typically offered by an employer 222 or worker 224. An employer 222, likewise, may be in need of services offered by a worker 224 for performing work for a client 226. An endorser 228, as described more fully herein, may be an employer 222, worker 224, client 226 or a third party not otherwise involved with the service system 200.

Each user 220 may interact and transact with the service database 201 through a user device 204. The user device 204, as described herein, may access or launch a web browser 314 or an application 324 on the device 204 for enabling specific interactions the database 201 and triggering interactions between the database 201 and the blockchain ledger 100, including additions 241 and confirmations 242, via user inputs 308. The web browser 314 or the application 324 may enable a user 220 to securely login for creating and/or accessing their user profile 214, stored on the user device 204 and/or service database 201. Upon initial creation of a user profile 214, numerous methods may be employed to confirm the identity of the user 220, including but not limited to linking to a social media account, manual or in-person confirmation, accessing third party databases and identification verification services or databases. A verification of the user identity 250 or other user attribute 216 may be included in the user profile 214 as a user attribute 216 and may be in the form of a certificate from a third party, for example.

Each user profile 214 may have corresponding user attributes (or user attribute metadata) 216. User attributes 216 may include one or more of the following: user ID 250, pseudo user ID or public key 217 (which has a one-to-one association with the user ID), private key 221 paired with the user public key 217 (i.e., using public-key or asymmetric cryptography), reputation score 210, reviews 244, comments 231, ratings 251, creation date 260, last update date 252, verification status 253, job history 254, location 255, name 256, contact information 257, possessions 206, notes 258, and keywords 259. Other user attributes 216 (not shown) for a worker 224 may further include one or more of the following: education 261, pay desired 262, desired jobs 263 and skills offered 264. Other user attributes 216 (not shown) for an employer 222 may further include one or more of the following: pay desired 262, pay offered 265, offered jobs 266, desired jobs 263, skills desired 267 and skills offered 264. Other user attributes 216 (not shown) for an client 226 may further include one or more of the following: pay offered 265, offered jobs 266 and skills desired 267.

Once a user profile 214 is created, the device 204 may store the user profile 214 on the service database 201. The service database 201 may, in turn, store all or a portion of the user profile 214 on the blockchain ledger 100 for creating an immutable and verifiable record. According to one embodiment of the invention, when a user profile 214 is created or updated, only the public key 217 (associated with the user ID 250), user reputation score 210, verification status 253, reviews 244, user profile creation date 260, and last updated date 252 is stored on the blockchain ledger 100.

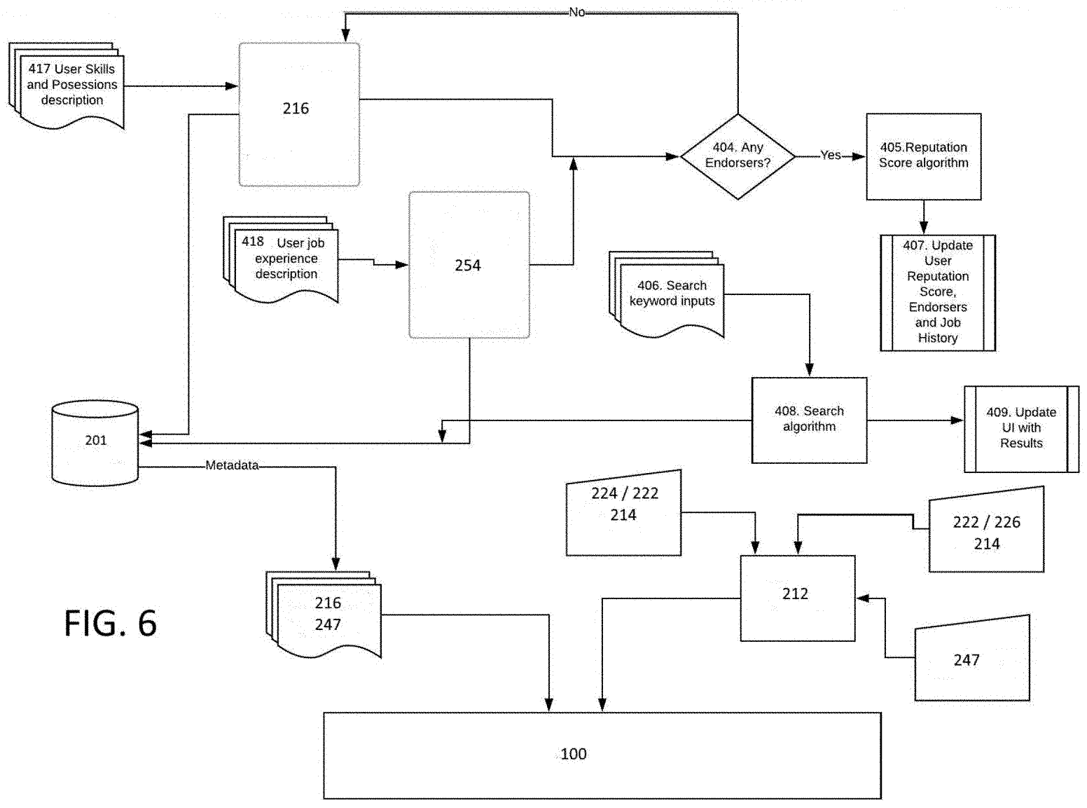

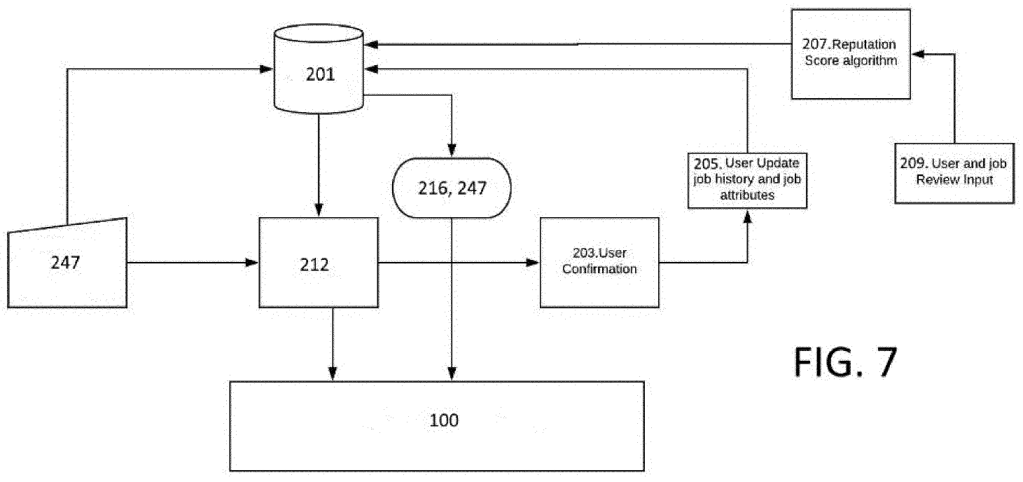

A user 220 may interact with a user device 204 for communicating to and enabling the service database 201 to communicate an addition 241 with the blockchain-based ledger 100. One type of addition 241 involves creating or updating a user profile 214. Another type of addition 241 communicated from the service database 201 to the blockchain ledger 100 is a transaction 246 (see., e.g., FIGS. 6 and 7).

A transaction 246 is created by a user 220 and is, initially, associated with a single worker 224, employer 222 or client 226. For example, a transaction 246 may be a job posting or advertisement for a service needed or offer of a service. Through an application 202 on a user device 204, a transaction 246 may be created and associated with a user profile 214 using the public key 217 for storage on the service database 201. The transaction 246 may include a transaction attributes 247 for storage, which may include one or more of the following: the transaction ID 270, the transaction title 271, the transaction amount 272, the transaction date 273, the transaction description 274, transaction requirements 275, transaction pay 276, transaction status 248, transaction work score 277, transaction comments 278, and any of the transaction creator's user attributes 216. The transaction 246 may be stored on the service database 201 and/or the blockchain ledger 100 and may include components of the transaction creator's user profile 214 (e.g., the public key 217, user reputation score 210, verification status, reviews 244, last updated date) and components of the transaction's transaction profile 247.

The transaction status 248 may be designated as draft (wherein the transaction 246 is stored on the user device 204 only, not yet communicated to the service database 201), proposal (submitted to service database 201 for storage thereon and with the ledger 100), under review (at least one worker 224 has applied for the transaction 246), in progress (a worker 224, as well as an employer 222 or a client 226 has digitally signed the transaction 246), done (the worker 224 has been paid by the employer 222 or the client 226) or inactive (transaction 246 is removed or work is not approved by employer 222 or client 226).

The service database 201 of the system 200 may include a module 526 for permitting users 220 to search through user profiles 214 and/or transactions 246. A user 220 may search for matches or relevant user attributes 216 and/or transaction attributes 247. The database 201 may retrieve the corresponding user profiles 214 and/or transaction 246 for displaying the corresponding profile 214 and/or transaction 246 on the user device 204.

The module 526 may receive user inputs 308 (e.g., inputs corresponding to the user attributes 216 and/or transaction attributes 247 being sought by a user 220) from a user device 204 for querying the service database 201 and/or blockchain-based ledger 100. A search algorithm (a combination of the operation system 510 and special-purpose circuitry 522, for example) may display users 220 in accordance with their reputation score 210. A user 220 may input a specific display parameter corresponding to any of the user attributes 216 and/or transaction attributes 247. For example, the matched or relevant transaction profiles 247 may be displayed according the transaction profile creator's corresponding reputation score 210 or the transaction date 273.

Once a transaction 246 is discovered through a search, a user 220 may submit a bid 400 to the database 201 corresponding to the transaction 246, thereby offering to be the second user/party to a contract 212 involving the transaction 246. The bid 400 may be in the form of a user input 308 through the user device 204. The bid 400 may be a simple acceptance of the transaction 246 or may include counter proposals 402 requesting changes to certain transaction attributes 247 (e.g., transaction date 273 or amount 272). The server database 201 may receive the bid 400 and any corresponding counter proposals 402 for communication to the user 220 who created the transaction 246. The service database 201 may send a notice of the bid 400 and/or counterproposal 402 to the user 220 who created the transaction 246, who may then review the bid 400, the counterproposals 402, and/or the user profile 214 corresponding to the user 220 who made the bid 400 and/or the counterproposals 402. Additional bids 400 and/or counterproposals 402 may be repeatedly communicated between users 220 until both a bid 400 and a set of counterproposals 402 is accepted by two or more users 220.

The service system 200 may be further configured for the creation, modification, auditing, tracking and execution of contracts 212. These contracts 212 may be enforceable between users 220 for employment of services or rental/use of possessions 206 and may include any number of legal clauses. Acceptance of a transaction 246, bid 400 and/or one or more counterproposals 402 may be effectuated by two or more users 220 (e.g., a worker 224 and an employer 222) applying digital signatures using their private key 221 thereto. Once signed by the users 220, a contract 212 may be formed by the database 201 including one or more transaction attributes 247, user attributes 216, and/or one or more counterproposals 402. The contract 212 may then be stored on the database 201 and associated with the corresponding transaction 246 stored thereon. The database 201 may then update the transaction job status 248 to ‘in progress’ and store transaction attributes 247 to the blockchain ledger 100. The contract 212 may include state-specific employment clauses on the location where the user is geographically located providing services.

Upon the fulfillment of a contract 212, a user 220 of the contract 212 may again digitally sign the contract using their private key 221. The user 220 may also submit digital evidence 290 evidencing the fulfillment or partial fulfillment of the contract 212. Digital evidence 290 may take the form of photos, videos, or text, for example. The contract 212, digitally signed as complete by one or more users 220, may be stored on the database 201, along with any digital evidence 290. An employer 222 and/or client 226 associated with the contract 212 may then review the contract 212, along with any digital evidence 290, if submitted, to determine whether the contract 212 has in face been fulfilled. If fulfilled, the employer 222 and/or client 226 associated with the contract 212 may also digitally sign the contract 212 as completed with their private key 221. If unfulfilled, the employer 222 and/or client 226 associated with the contract 212 may submit a rejection to the service database 201 for review.

Once a contract 212 has been digitally signed as fulfilled by the worker 224 and the employer 222 and/or client 226, automatic payment may be made to the worker 224 if the employer 222 and/or client 226 has a digital wallet 336 having a sufficient balance to cover the payment amount 272 of the contract 212. The payment amount 272 (which may have been updated by a counterproposal 402) may be transferred from the digital wallet 336 of the employer 222 and/or client 226 to the digital wallet 336 of the worker 224 or may be used to send a check or make a direct deposit to the worker 224. In other embodiments, the service database 201 may communicate with the employer 222 and/or client 226 for presenting the payment amount 272 due. Worker 224 may digitally sign a payment communication to the service database 201 confirming that the payment amount 272 has been received. Once confirmation of receipt of payment is received by the service database 201, either from the worker 224 or through automatic transfer by the database 201 using one or more digital wallets 336, the transaction job status 248 may be updated to ‘done’ in the database 201 and the transaction attributes 247 may again be stored on the blockchain ledger 100.

In addition to updating the transaction 246, the user profiles 214 associated with the worker 224, and/or the employer 222 and/or client 226 may be updated. For example, the job history 254 may be updated to include the completed transaction 246. Further, once the transaction 246 is ‘done’, each participating user 220 may provide a review 244 and/or comment 231 for other participating users 220, the review 244 and/or comment 231 associated with both the corresponding transaction 246 and the corresponding user profiles 214. The review 244 may be a numeric input 308, whereas the comment 231 may be an alphanumeric input 308. The corresponding user profiles 214 may be stored in the database 201 and the ledger 100 and include the additional or new review(s) 244 and/or the comment(s) 231. In one embodiment, participating users 220 are prompted by the database 201, through the web browser 314 and/or the application 324 to provide a review 244 and/or comment 231 once the transaction 246 is ‘done’.

The fulfillment, partial fulfillment or non-fulfillment of the contract(s) 212 and the review(s) 244 may be used to alter the reputation score 210 of the users 220. Fulfillment of contractual obligations may increase the reputation score 210. Non-fulfillment or partial fulfillment of contractual obligations may decrease the reputation score 210. One embodiment of the formula for calculating a new reputation score 210 is calculated using the following formula: (rating 251+review 244*transaction weight+current reputation score*total user reviews to date)/(1+total user reviews to date).

A review 244 may range from 0 to 5 or 1 and 5 and be an integer or real number, for example. A rating 251 may range from −5 to 5 and be an integer or real number. A rating 251 may correspond to the transaction 246 as a whole, whereas the review 244 may correspond to the particular user 220 only. For example, the rating 251 may be a −5 when the transaction 246 is inactive and the contract 212 is unfulfilled. If the contract 212 is partially fulfilled, the rating 251 may range between −5 and −1 according to the severity of the breach or unfulfillment of the contract 212. For a cancelled transaction 246, the rating 251 may be zero. For a transaction 246 that is ‘done’ and the contract 212 being fulfilled, the rating 251 may range between 0 and 5 or 1 and 5 and correspond to the quality of the work. For breached contracts 212, the platform administrator may review and assigned the negative score. For fulfilled contracts 212, the rating 251 may be and average of the reviews 244 submitted by the users 220 corresponding to the contract 212. Users 220 may report irregularities that will prompt the platform administrator to review, and potentially reformulate, reviews 244 and/or ratings 251. In some embodiments, the transaction weight for a rating 251 submitted with four weeks of contract 212 completion is one, whereas a transaction weight for a rating 251 submitted after the four weeks is decreased by a factor, say 10% (or some other percentage between 0% and 50%), every four weeks thereafter.

The ratings 251, reviews 244 and other information disclosed herein may be used to calculate an updated reputation score 210 associated with a user 220 for storage in the database 201 and/or the ledger 100. A reputation algorithm may further make determinations of the reputation score 210 using the job history 254, endorsers 228, other feedback. A reputation scoring system driven by the success or failure of each party to fulfill the obligations contracted in the smart contract and crowd-sourced user ratings for the quality of the services provided by the user, customer service, moral behavior, number of endorsers, timely payment of services contracted among other attributes and feedback entered by other system users.

Any user 220 may be an endorser 228 once their corresponding user profile 214 is verified. Any endorser 228 may review and confirm an attribute 216 of a user profile 214 for verifying (or assisting in the verifying of) the user profile 214. Endorsers 228 may be verified as being previous customers or employers of a worker 224, though a customer or employer outside the system 200 and unrelated to a contract 212 or transaction 246 of the system 200. Client-endorsers 228 can provide feedback on job performance of a worker 224. Client- and worker-endorsers 228 may provide feedback on employers 222 that provide services. Worker- and employer-endorsers 228 may provide feedback on clients 226 that receive services.

The system 200 may enable a chat feature for allowing users 220 of the system 200 to communicate directly with each other.

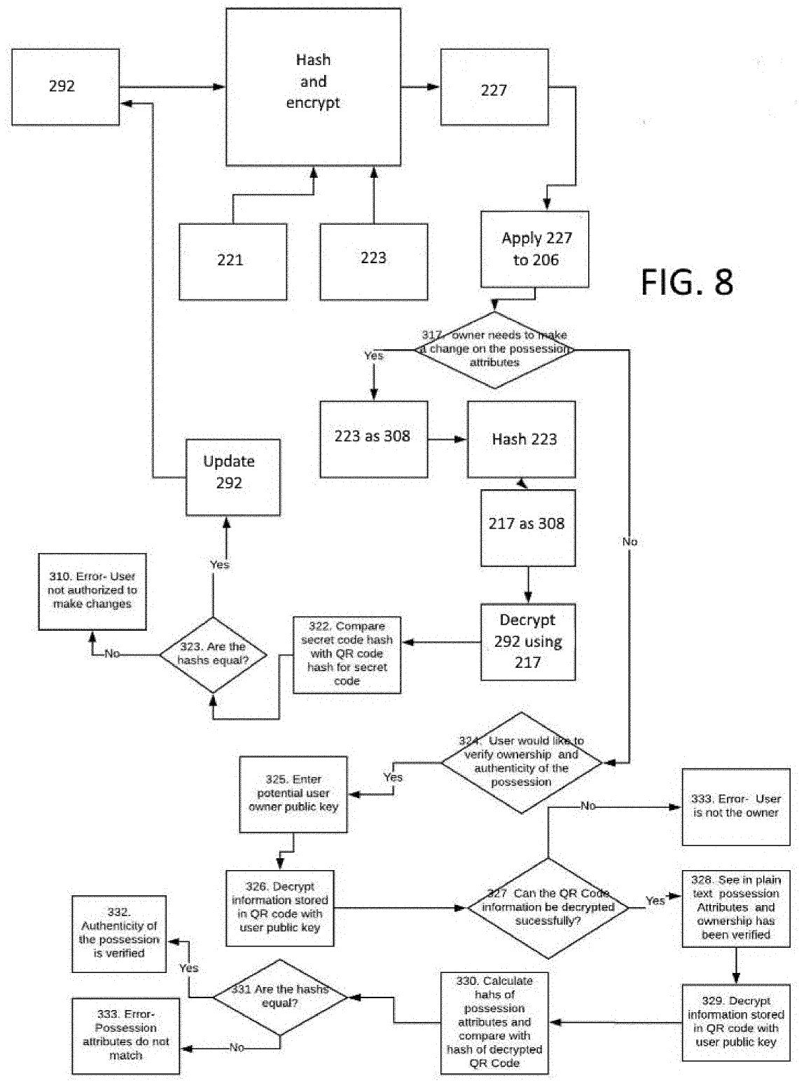

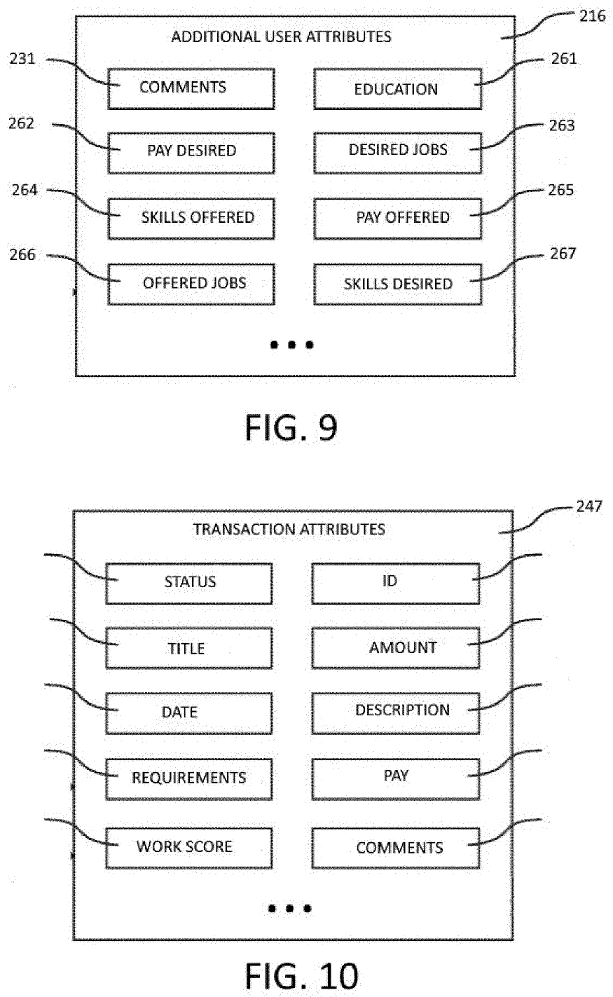

The system 200 may further enable user 220 to create and execute contracts 212 for providing the service of loaning, renting or selling a possession 206 for use by another user 220. See, e.g., FIG. 8. According to one embodiment of the invention, the user device 204 may apply the user private key 221 and a cryptographic hash algorithm to create an encrypted verification hash 116V from the possession metadata 206. Possession metadata 206 may include attributes corresponding to the transaction attributes 247 and/or user attributes 216. For examples, possessions 206 may include an ID, title, amount, date, description, requirements, skills, comments, keywords, job history, etc. Further, the user device 204 may apply the private key 221 and a cryptographic hash algorithm to create an encrypted secret code hash 116S from the user secret code 223. Finally, the user device 204 may further create an QR code 227 from the encrypted hashes 116V, 116S and the possessions 206 using the public key 217. The QR code 227 may be stored on the blockchain-based ledger 100 to finalize the account creation. Until the user account 202 is endorsed, the reputation score for the account 202 remains null (0). These same steps for account creation may be the initial steps for account verification or account updates.

For an account verification, the user device 204 further communicates a user public key 217 for decrypting the corresponding QR code 227 to view the corresponding possessions 206. The decrypted possessions 206 may then be hashed to create a decrypted verification hash 116D. The decrypted verification hash may be compared to the encrypted hash 116S of the QR code. If the hashes 116D, 116S are equal, the authenticity of the user device 204 and/or user 220 is verified.

Once authenticity is verified, a user device 204 may communicate the secret code 223, which may be hashed to create a mirror secret hash 116M, which may be compared to the decrypted secret hash 116S. If the hashes 116S, 116M are equal, the user device 204 may modify the attributes 216.

Ownership can be transferred to new users and a new QR code and hash is attached to the history of the object and stored in a distributed ledger network. When a possession 206 ownership is transferred to new owner, a new QR code and hash is attached to the history of the possession 206 and stored in a distributed ledger network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, or the like. The program code may execute entirely on the user's computer, partly on the user's computer, as a stand-alone software package, partly on the user's computer, and partly on a remote computer or entirely on the remote computer or server.

Aspects of the present invention are described in the instant specification with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a user” can include a plurality of such users, and so forth. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system comprising:
at least one processor; and
at least one storage medium for storing instructions for execution by the at least one processor for causing the system to:
receive from a first user device first user attributes and transaction attributes;
receive from a second user device second user attributes and a bid corresponding to the transaction attributes;
receive from the first user device an acceptance of the bid;
create a contract including components of the first user attributes, second user attributes and the transaction attributes; and
store some of the components on a blockchain-based ledger.
